(19) United States
(12) Patent Application Publication
(10) Pub. No.: US 2021/0216815 A1
(43) Pub. Date: Jul. 15, 2021

(54) ELECTRONIC APPARATUS AND OPERATING METHOD THEREOF

(71) Applicant: SAMSUNG ELECTRONICS CO., LTD., Suwon-si (KR)

(72) Inventor: Woochan LEE, Suwon-si (KR)

(21) Appl. No.: 17/146,748

(22) Filed: Jan. 12, 2021

(30) Foreign Application Priority Data
Jan. 14, 2020 (KR) 10-2020-0004949

(51) Int. Cl. G06K 9/62; G06F 3/0482; G06N 20/00

(52) U.S. Cl. CPC G06K 9/6254; G06K 9/6257; H04L 51/24; G06K 9/6268; G06N 20/00; G06F 3/0482

(57) ABSTRACT

Provided are an electronic apparatus and an operating method thereof. The operating method of the electronic apparatus may include: detecting occurrence of an event in the electronic apparatus, and determining whether to output notification information about the detected event using a learning model trained based on a user response pattern in response to a certain event including a certain context.

### CROSS-REFERENCE TO RELATED APPLICATION

This application is based on and claims priority under 35 U.S.C. § 119 to Korean Patent Application No. 10-2020-0004949, filed on Jan. 14, 2020, in the Korean Intellectual Property Office, the disclosure of which is incorporated by reference herein in its entirety.

### BACKGROUND

### 1. Field

The disclosure relates to an electronic apparatus and an operating method thereof, and for example, to an electronic apparatus outputting notification information with respect to an event that is meaningful to a user, and an operating method thereof.

### 2. Description of Related Art

An artificial intelligence (AI) system may refer, for example, to a computer system that implements human-level intelligence and allows a machine to learn by itself, judge, and become smarter unlike existing rule-based smart systems. The more the AI system is used, the more a recognition rate improves and a user's preference is more accurately understood. Thus, existing rule-based smart systems are gradually being replaced by deep learning-based AI systems.

AI technology includes machine learning (deep learning) and element technologies that utilize the machine learning.

Machine learning may refer, for example, to an algorithm-based technology that self-classifies/learns characteristics of input data. Element technology may refer, for example, to a technology that simulates functions of the human brain such as recognition and judgement using machine learning algorithms such as deep learning, and may include technical fields such as linguistic understanding, visual understanding, inference/prediction, knowledge representation, and motion control.

The AI technology may be applied to various fields as follows. Linguistic understanding may refer, for example, to a technique of recognizing and applying/processing human language/characters, including natural language processing, machine translation, dialogue system, query response, speech recognition/synthesis, or the like. Visual understanding may refer, for example, to a technique to recognize and process objects as performed in human vision, including object recognition, object tracking, image search, human recognition, scene understanding, spatial understanding, image enhancement, or the like. Inference/prediction may refer, for example, to a technique of judging, logically inferring and predicting information, including knowledge/probability-based inference, optimization prediction, preference-based planning, recommendation, or the like. Knowledge representation may refer, for example, to a technique of automatically processing human experience information into knowledge data, including knowledge building (data generation/classification), knowledge management (data utilization), or the like. Motion control may refer, for example, to a technique of controlling autonomous travel of a vehicle and a motion of a robot, including movement control (navigation, collision-avoidance, and traveling), operation control (behavior control), or the like.

Recently, as electronic apparatuses that complexly perform various functions using the AI technology are developed, electronic apparatuses that provide services suitable for individual users are being developed.

Research is being conducted into a method of providing an appropriate notification with respect to an event that is meaningful to a user from among various events occurring in an electronic apparatus.

### SUMMARY

Embodiments of the disclosure provide an electronic apparatus outputting notification information with respect to an event that is meaningful to a user, and an operating method thereof.

Embodiments of the disclosure provide a non-transitory computer-readable recording medium having recorded thereon a program for executing the operating method on a computer. However, the technical problems are not limited to the aforementioned technical features, and other unstated technical problems may exist.

Additional aspects will be set forth in part in the description which follows and, in part, will be apparent from the description.

According to an example embodiment of the disclosure, an operating method of an electronic apparatus includes: detecting occurrence of an event in the electronic apparatus, and determining whether to output notification information about the detected event using a learning model trained based on a user response pattern in response to a certain event including a certain context.

In addition, the operating method of the electronic apparatus may further include classifying and storing the detected event in a notification output list as the notification information is determined to be output and classifying and storing the detected event in a notification pending list as outputting of the notification information is determined to be suspended.

In addition, the operating method of the electronic apparatus may further include outputting notification information notifying a user about the event classified and stored in the notification output list.

According to an example embodiment of the disclosure, an electronic apparatus includes: a memory storing one or more instructions, and a processor configured to execute the one or more instructions stored in the memory to: detect occurrence of an event in the electronic apparatus, and determine whether to output notification information about the detected event using a learning model trained based on a user response pattern in response to a certain event including a certain context.

In addition, the processor may be further configured to execute the one or more instructions to: classify and store the detected event in a notification output list as the notification information is determined to be output and classify and store the detected event in a notification pending list as outputting of the notification information is determined to be suspended.

In addition, the processor may be further configured to execute the one or more instructions to: output notification information notifying a user about the event classified and stored in the notification output list.

According to an example embodiment of the disclosure, a non-transitory computer-readable recording medium has recorded thereon a program for executing the operating method on a computer.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example of an electronic apparatus operating, according to various embodiments;

FIG. 2 is a flowchart illustrating an example method of operating an electronic apparatus, according to various embodiments;

FIG. 3 is a flowchart illustrating an example of outputting notification information, according to various embodiments;

FIG. 4 is a diagram illustrating an example of training a learning model with a user response pattern in response to an event, according to various embodiments;

FIG. 5 is a flowchart illustrating an example of training a learning model with a user response pattern in response to notification information, according to various embodiments;

FIG. 6 is a flowchart illustrating an example of training a learning model with a user response pattern related to a notification pending list, according to various embodiments;

FIG. 7 is a flowchart illustrating an example of training a learning model with a user response pattern related to a notification output list, according to various embodiments;

FIG. 8 is a diagram illustrating an example of training a learning model with a list based on a classification input of a user, according various embodiments;

FIG. 9 is a flowchart illustrating an example of training a learning model with a list based on a classification input of a user, according to various embodiments;

FIG. 10A is a diagram illustrating an example of a user interface related to a classification input of a user, according to various embodiments;

FIG. 10B is a diagram illustrating an example of a user interface related to a classification input of a user, according to various embodiments;

FIG. 11 is a signal flow diagram illustrating an example of receiving an event generated in an external apparatus, according to various embodiments;

FIG. 12 is a block diagram of an example electronic apparatus according to various embodiments; and

FIG. 13 is a block diagram illustrating an example electronic apparatus, according to various embodiments.

### DETAILED DESCRIPTION

Hereinafter, the disclosure will be described in greater detail with reference to the accompanying drawings. The disclosure may, however, be embodied in many different forms and should not be understood as being limited to the embodiments set forth herein. Parts in the drawings unrelated to the detailed description may be omitted to ensure clarity of the present disclosure. Like reference numerals in the drawings denote like elements.

The terms used in the present disclosure are typically general terms currently widely used in the art in consideration of functions in the present disclosure, but the terms may vary according to the intention of one of ordinary skill in the art, precedents, or new technology in the art. Accordingly, the terms used in the disclosure should not be interpreted based on only their names but should to be interpreted based on the meaning of the terms together with the descriptions throughout the disclosure.

Throughout the disclosure, the expression “at least one of a, b or c” indicates only a, only b, only c, both a and b, both a and c, both b and c, all of a, b, and c, or variations thereof.

While such terms as “first,” “second,” etc., may be used to describe various components, such components must not be limited to the above terms. The above terms are used simply to distinguish one component from another.

Also, the terminology used herein is for the purpose of describing embodiments only and is not intended to be limiting of embodiments. As used herein, the singular forms “a”, “an”, and “the”, are intended to include the plural forms as well, unless the context clearly indicates otherwise. Throughout the disclosure, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

The use of the terms “a” and “an” and “the” and similar referents in the context of describing the disclosure (especially in the context of the following claims) is to be construed to cover both the singular and the plural. Operations of all methods described herein may be performed in any suitable order unless otherwise indicated herein or otherwise clearly contradicted by context. The disclosure is not limited to the described order of the steps.

The phrases “in some embodiments” or “in an embodiment” throughout the disclosure do not necessarily all refer to the same embodiment.

The present disclosure may be described in terms of functional block components and various processing steps. Some or all of such functional blocks may be realized by any number of hardware and/or software components configured to perform the specified functions. For example, the functional blocks of the disclosure may be realized by one or more microprocessors or circuit components for performing predetermined functions. Also, the functional blocks may be implemented with various programming or scripting languages. The functional blocks may be implemented in algorithms executed on one or more processors. The present disclosure may employ any number of techniques according to the related art for electronics configuration, signal processing and/or control, data processing and the like. The term “mechanism”, “element”, “unit”, or “configuration” may be used broadly and is not limited to mechanical and physical embodiments.

Furthermore, the connecting lines, or connectors shown in the various drawings are intended to represent example functional relationships and/or physical or logical couplings between the various elements. It should be noted that many alternative or additional functional relationships, physical connections, or logical connections may be present in a practical device.

The disclosure will now be described in greater detail with reference to the accompanying drawings.

An event according to an embodiment may refer, for example, to information or an action that occurs through an application installed in an electronic apparatus 100 or may be received from the outside. For example, the event may include message reception (for example, short message service (SMS) reception, multimedia messaging service (MMS) reception), email reception, missed call notification reception, an advertisement occurring in an installed application, a notification (for example, a schedule notification set in a schedule application, a purchase advertisement notification in a shopping application, or the like), a notification of update information of an installed application, a notification of a change related to the setting of the electronic apparatus 100 (for example, an operating system (OS) update notification), or the like, but is not limited thereto.

According to an embodiment, a context included in an event may refer, for example, to whether a detected event is related to a certain application, is related to a certain date, time, place, person, or the like, is related to a certain text or keyword, is related to a certain image, is related to a certain external apparatus, or the like. For example, when a message reception event is detected, the context may refer to a sender of the message, a reception date of the message, a text (for example, “special price”, “promotion”, or the like) included in the title, content, or the like of the message, an image, or the like.

According to an embodiment, notification information may refer, for example, to information provided such that a user may check a detected event. The notification information may be determined differently according to the type of an event, the content of an event, or the like. For example, the notification information with respect to a message reception event may include a sending date and time of the message, sender information of the message, a title of the message, at least some contents of the message, or the like. In addition, for example, the notification information with respect to a missed call notification reception event may include caller information of the call, date and time of the call, number of missed calls, or the like.

According to an embodiment, a notification output list may refer, for example, to a list including an event determined to output notification information related to an event among detected events.

According to an embodiment, a notification pending list may refer, for example, to a list including an event determined to suspend outputting notification information related to an event among detected events.

According to an embodiment, a user response pattern may refer, for example, to a response pattern based on and input, e.g., a user input, such as whether a user confirms or deletes notification information when an event is detected and the notification information is provided.

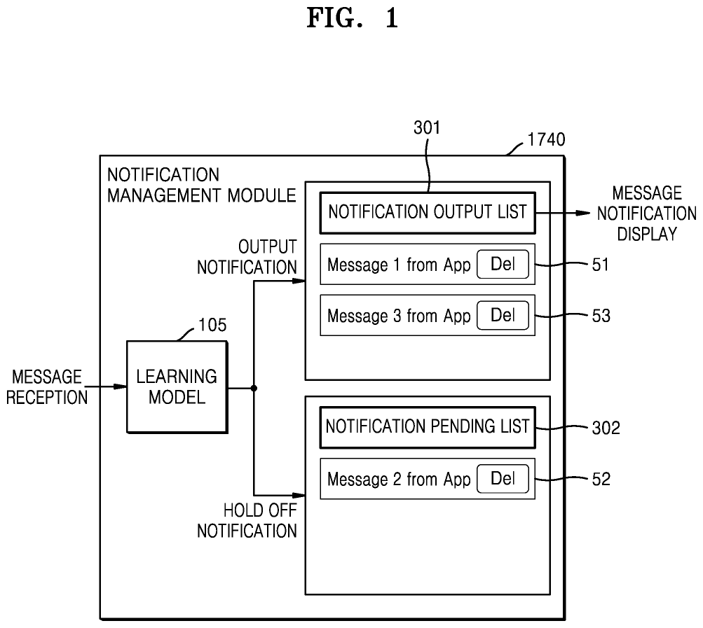

FIG. 1 is a diagram illustrating an example of the electronic apparatus 100 operating, according to various embodiments.

According to an embodiment, when an event is detected in the electronic apparatus 100, the electronic apparatus 100 may determine, using a learning model (e.g., including various processing circuitry and/or executable program elements) 105 trained using an artificial intelligence algorithm, whether to provide a notification to a user about the occurrence of the event or to suspend the provision of a notification.

In a daily use environment, a user may want to receive notifications only with respect to information that is meaningful and of interest to the user, but when a number of notifications with respect to information of no interest to the user are provided, inconvenience due to unnecessary notifications may occur.

According to an embodiment, when an event occurs and notification information is provided, the electronic apparatus 100 may train the learning model 105 using, as training data, a user response pattern with respect to notification information of an event.

According to an embodiment, the inconvenience of which a user receives a number of unnecessary notifications may be eliminated by that the electronic apparatus 100 provides a notification using the learning model 105 that has been trained based on a user response pattern, the notification being with respect to an event recognized as an event that the user considers important and is interested in.

According to an embodiment, when an event occurs, the electronic apparatus 100 may, using the learning model 105 that has been trained, classify and store the event in a notification output list or a notification pending list and may provide a notification with respect to an event stored in the notification output list and suspend the provision of a notification with respect to an event stored in the notification pending list.

For example, the learning model 105 may determine, as being included in the notification output list, an event including a context showing a response pattern that the user previously confirmed to be of interest or the like, and may determine, as being included in the notification pending list, an event including a context showing a response pattern that the user deletes without confirmation or the like.

For example, FIG. 1 illustrates an example in which a Message 1 51 and a Message 3 53 are stored in a notification output list 301 and a Message 2 52 is stored in a notification pending list 302.

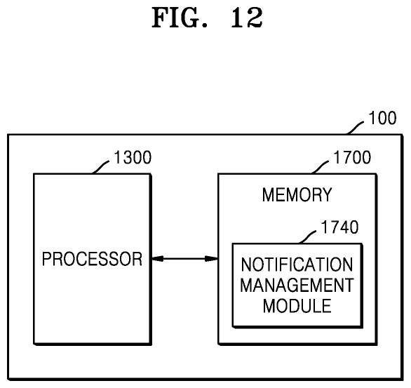

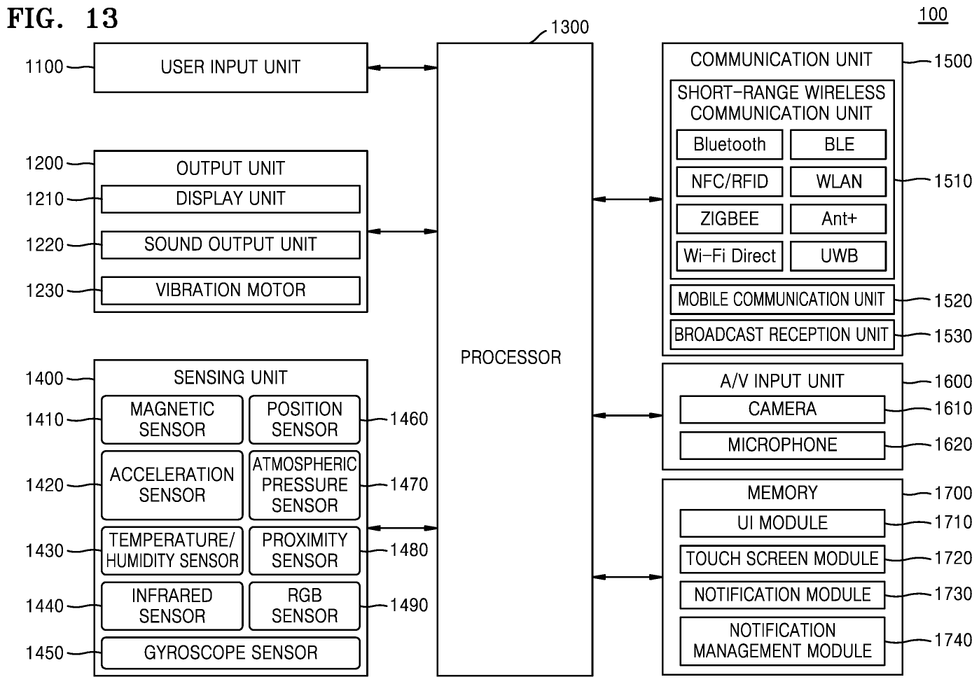

Referring to FIG. 1, for example, when a message reception event occurs in the electronic apparatus 100, a processor (e.g., including processing circuitry) 1300 (refer to FIGS. 12 and 13) of the electronic apparatus 100 may call a notification management module 1740 (refer to FIGS. 12 and 13) included in a memory 1700 (refer to FIGS. 12 and 13) to use the learning model 105 to determine whether to output a notification with respect to a received message or to suspend the output of the notification.

According to an embodiment, the electronic apparatus 100 may classify and store a detected event in the notification output list 301 as the electronic apparatus 100 determines to output notification information, and may classify and store a detected event in the notification pending list 302 as the electronic apparatus 100 determines to hold off the output of notification information. For example, the electronic apparatus 100 may store a message in the notification output list 301 as the electronic apparatus 100 determines to output a notification with respect to a received message and may display notification information notifying a user about the received message on a display 1210 (refer to FIG. 13). In addition, for example, the electronic apparatus 100 may store the message in the notification pending list 302 as the electronic apparatus 100 determines to suspend outputting of the notification information with respect to the received message.

The electronic apparatus 100 according to an embodiment may be implemented in various forms, such as, for example, and without limitation, a smart phone, a television (TV), a wearable device, a tablet personal computer (PC), a desktop, a laptop computer, a mobile phone, an e-book terminal, a digital broadcasting terminal, a personal digital assistant (PDA), a portable multimedia player (PMP), a digital camera, a camcorder, a navigation device, a MP3 player, a media player, a micro-server, a global positioning system (GPS) device, or the like.

In addition, the electronic apparatus 100 may include a fixed electronic apparatus arranged in a fixed location or a mobile electronic apparatus having a portable form, and may include a digital broadcast receiver capable of receiving digital broadcasts.

In addition, the learning model 105 may be constructed considering, for example, and without limitation, an application field of the learning model 105, a purpose of learning, computer performance of an apparatus, or the like. The learning model 105 may be, for example, a model based on a neural network. For example, a model such as a deep neural network (DNN), a recurrent neural network (RNN), and a bidirectional recurrent deep neural network (BRDNN) may be used as the learning model 105, but is not limited thereto.

According to an embodiment, the learning model 105 may include a plurality of neural network layers. Each of the plurality of neural network layers may have a plurality of weight values, and a neural network operation may be performed through an operation between an operation result of a previous layer and the plurality of weight values. The plurality of weight values of the plurality of neural network layers may be optimized by a learning result of the learning model 105.

FIG. 1 is a diagram illustrating an example embodiment and the disclosure is not limited thereto.

Hereinafter, various example embodiments will be described in greater detail below with reference to drawings.

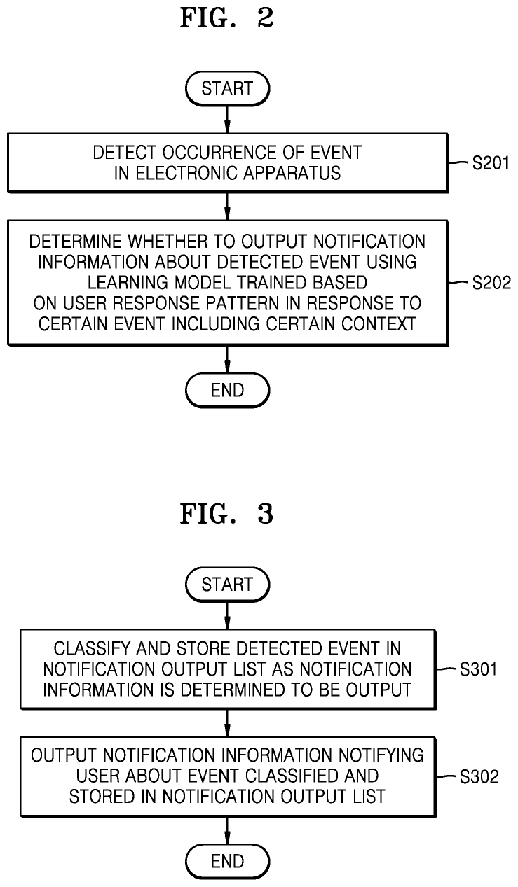

FIG. 2 is a flowchart illustrating an example operating method of the electronic apparatus 100 according to various embodiments.

In operation S201 of FIG. 2, the electronic apparatus 100 may detect occurrence of an event in the electronic apparatus 100.

An event according to an embodiment may refer, for example, to information or an action that occurs through an application installed in the electronic apparatus 100 or is received from the outside. For example, the electronic apparatus 100 may detect message reception, email reception, a missed call notification reception notification, an advertisement occurred in an application, a notification, or the like.

In operation S202 of FIG. 2, the electronic apparatus 100 may determine whether to output notification information about the detected event using the learning model 105 trained based on a user response pattern in response to a certain event including a certain context.

According to an embodiment, the electronic apparatus 100 may train the learning model 105 using, as training data, a user response pattern indicating how a user responds when an event including a certain context occurs.

For example, when a new message is received by the electronic apparatus 100, the user may check the content of the message. The user may repeatedly check a message several times or separately manage the message as an important message when the message includes content of interest to the user, includes important content, or is received from a sender who the user is interested in. However, when the message is not of interest to the user and unnecessary, the user may read the message once and delete the message or may delete the message without checking the content of the message. In addition, the user may check only a sender of the message and delete the message immediately when the message appears as an advertisement message.

According to an embodiment, the electronic apparatus 100 may refine the learning model 105 by continuously training how a user responds to a certain event including a certain context. The electronic apparatus 100 may, using the refined learning model 105, determine whether the user wants to receive a notification output with respect to a current event based on a past response pattern of the user.

In addition, according to an embodiment, the electronic apparatus 100 may classify a detected event into a list corresponding to determination of whether to output notification information among a notification output list or a notification pending list, and store the detected event in the memory 1700 (refer to FIG. 12).

According to an embodiment, the processor 1300 of the electronic apparatus 100 may call the notification management module 1740 (refer fot FIG. 12) to classify and store a detected event in a notification output list as notification information of the detected event is determined to be output, and may classify and store the detected event in a notification pending list as notification information of the detected event is determined not to be output.

FIG. 3 is a flowchart illustrating an example of outputting notification information according to various embodiments.

In operation S301 of FIG. 3, the electronic apparatus 100 may classify a detected event into a notification output list as notification information is determined to be output and store the detected event in the memory 1700 (refer to FIG. 12). In operation S302, the electronic apparatus 100 may output notification information notifying a user about the event classified and stored in the notification output list.

According to an embodiment, when an event is detected, as the notification information is determined, using the learning model 105, to be output, the electronic apparatus 100 may display notification information on the display 1210 (refer to FIG. 13). In addition, the electronic apparatus 100 may output the notification information as sound through a sound output unit 1220 (refer to FIG. 13). Also, the electronic apparatus 100 may notify the user about message reception and missed call notification reception through vibration using a vibration motor 1230 (refer to FIG. 13), but is not limited thereto.

According to an embodiment, when an event is detected, the electronic apparatus 100 may classify the detected event into a notification pending list and store the detected event in the memory 1700 (refer to FIG. 12) as an output of notification information is determined, using the learning model 105, to be hold off, and thus, the notification information of the detected event may not be output and may be hold off. For example, when a message reception event is classified and stored in the notification pending list, the electronic apparatus 100 may not output notification information including a received message.

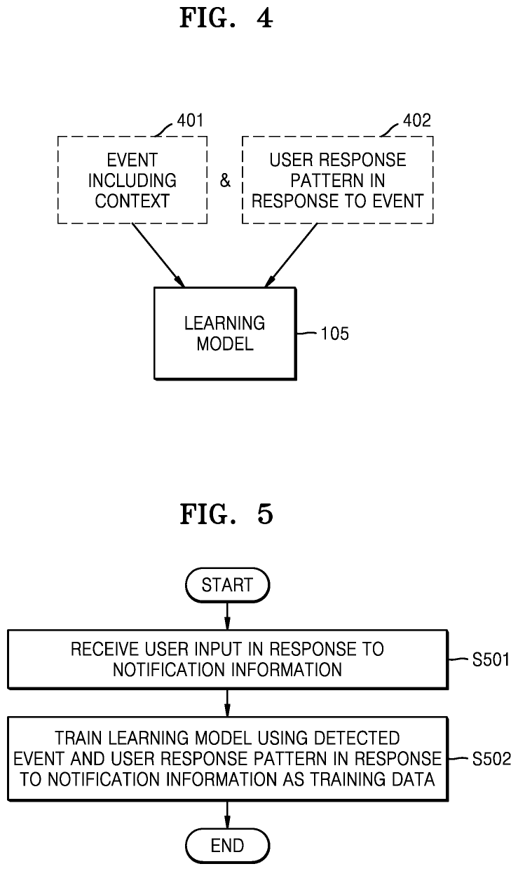

FIG. 4 is a diagram illustrating an example of training the learning model 105 with a user response pattern in response to an event, according to various embodiments.

According to an embodiment, the electronic apparatus 100 may train the learning model 105 using, as training data, an event 401 including a context and a user response pattern 402 in response to an event.

Example embodiments illustrating a user response pattern will be described in greater detail below with reference to FIGS. 5, 6 and 7.

FIG. 5 is a flowchart illustrating an example of training the learning model 105 with a user response pattern in response to notification information, according to various embodiments.

In operation S501 of FIG. 5, the electronic apparatus 100 may receive a user input in response to notification information.

According to an embodiment, when the electronic apparatus 100 outputs notification information related to a detected event, the electronic apparatus 100 may receive a user input in response to the notification information.

For example, the electronic apparatus 100 may display notification information including a received message on the display 1210 (refer to FIG. 13) as a message reception event is detected. The electronic apparatus 100 may receive a user input of checking and immediately deleting the received message, in response to the notification information including the received message. In addition, for example, the electronic apparatus 100 may manage and store the received message as an important message.

In operation S502 of FIG. 5, the electronic apparatus 100 may train the learning model using, as training data, a detected event and a user response pattern in response to notification information.

For example, the electronic apparatus 100 may train the learning model 105 using, as training data, a user response pattern in which a received message is immediately deleted in response to a message reception event.

In addition, the electronic apparatus 100 may train the learning model 105 using, as the training data, a user response pattern in which the received message is managed and stored as an important message, in response to the message reception event.

According to an embodiment, the electronic apparatus 100 may train the learning model 105 using, as training data, a detected event and a user response pattern in response to notification information. Accordingly, when the electronic apparatus 100 uses the learning model 105, the electronic apparatus 100 may recognize whether a notification with respect to an event including a certain text is of necessity to a user of the electronic apparatus 100 and may also recognize whether a notification with respect to an event including a certain text is not of necessity to the user of the electronic apparatus 100.

According to an embodiment, when notification information with respect to an event including a certain context that a user has responded with interest is output but a response pattern in which the user immediately deletes the notification information repeats more than a preset number of times, the electronic apparatus 100 may, in the future, classify and store an event including the certain context in a notification pending list and may not output notification information.

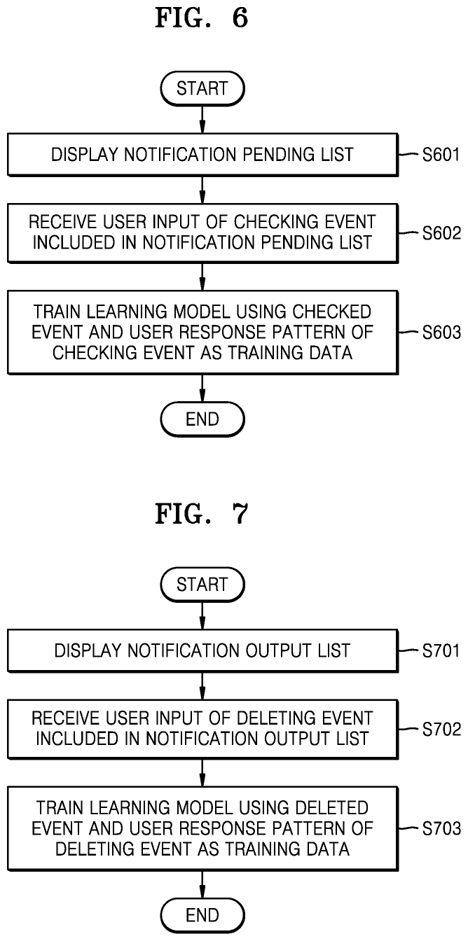

FIG. 6 is a flowchart illustrating an example of training the learning model 105 with a user response pattern related to a notification pending list, according to various embodiments.

In operation S601 of FIG. 6, the electronic apparatus 100 may display a notification pending list.

According to an embodiment, the electronic apparatus 100 may display, on the display 1210 (refer to FIG. 13), a stored notification pending list, based on a preset user input calling the notification pending list.

For example, a user may directly check a list of events stored in the notification pending list displayed on the display 1210.

In operation S602, the electronic apparatus 100 may receive a user input of checking an event included in the notification pending list.

For example, the user may repeat an action of accessing the notification pending list to directly check repeatedly several times a content of an event that has been classified in the notification pending list.

In operation S603 of FIG. 6, the electronic apparatus 100 may train the learning model 105 using, as training data, the checked event and a user response pattern of checking an event.

According to an embodiment, the electronic apparatus 100 may train the learning model 105 with a user response pattern that the user checks an event that has been classified in the notification pending list with interest.

Accordingly, when an event occurs in the future with respect to a context included in an event that the user has checked with interest, the electronic apparatus 100 may classify and store the event in the notification output list.

FIG. 7 is a flowchart illustrating an example of training the learning model 105 with a user response pattern related to a notification output list, according to various embodiments

In operation S701 of FIG. 7, the electronic apparatus 100 may display a notification output list.

According to an embodiment, the electronic apparatus 100 may display, on the display 1210 (refer to FIG. 13), a stored notification output list, based on a preset user input calling the notification output list.

For example, a user may directly check a list of events stored in the notification output list displayed on the display 1210.

In operation S702 of FIG. 7, the electronic apparatus 100 may receive a user input of deleting an event included in the notification output list.

For example, the user may delete an event that has been classified in the notification output list from the notification output list displayed on the display 1210.

In operation S703 of FIG. 7, the electronic apparatus 100 may train the learning model 105 using, as training data, the deleted event and a user response pattern of deleting an event.

According to an embodiment, when a user input of deleting an event that has been classified in the notification output list is received, the electronic apparatus 100 may recognize a user's intention that the user, in the future, does not want to receive notification information with respect to a context included in the deleted event.

The electronic apparatus 100 may train the learning model 105 with an event deleted by a user input and a user response pattern of deleting an event.

Accordingly, when an event occurs in the future with respect to a context included in an event that the user has deleted, the electronic apparatus 100 may classify and store the event in the notification pending list.

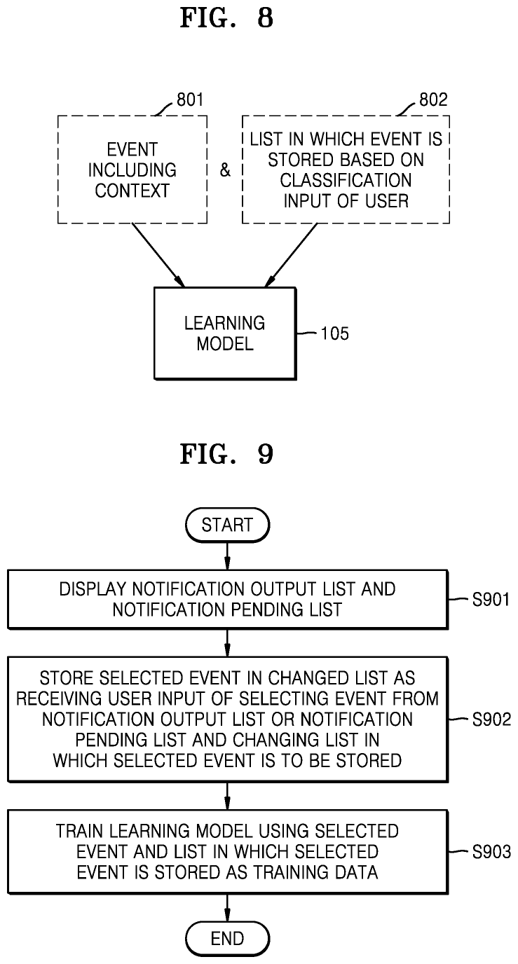

FIG. 8 is a diagram illustrating an example of training the learning model 105 with a list based on a classification input of a user, according various embodiments.

According to an embodiment, the electronic apparatus 100 may train the learning model 105 using, as training data, an event 801 including a context and a list 802 in which an event is stored based on a classification input of a user.

For example, the electronic apparatus 100 may receive a classification input in which an event that has been classified in the notification output list with respect to an email reception event sent by a sender A is changed to the notification pending list and stored. The electronic apparatus 100 may train the learning model 105 that the user has classified an email reception event including a context of the sender A in the notification pending list.

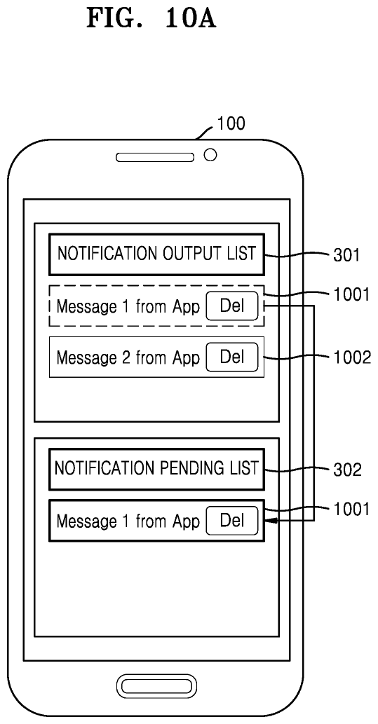

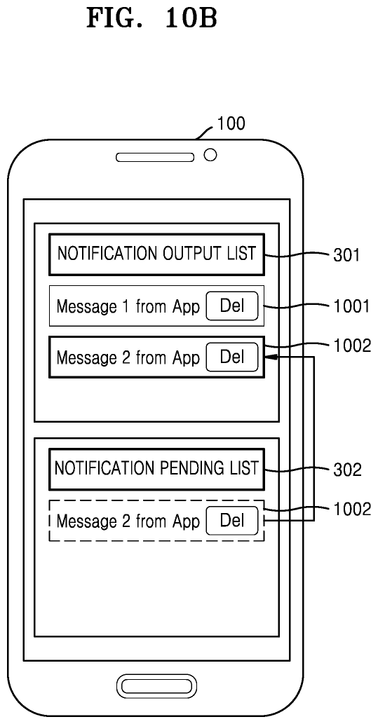

FIG. 9 is a flowchart illustrating an example of training the learning model 105 with a list based on a classification input of a user, according to various embodiments. FIGS. 10A and 10B are diagrams illustrating an example of a user interface related to a classification input of a user, according to various embodiments. FIGS. 10A and 10B are diagrams that may be referenced to explain the flowchart of FIG. 9.

In operation S901 of FIG. 9, the electronic apparatus 100 may display a notification output list and a notification pending list.

Referring to FIGS. 10A and 10B, according to an embodiment, the electronic apparatus 100 may display, on the display 1210 (refer to FIG. 13), a stored notification output list and notification pending list, based on a preset user input calling the notification output list and the notification pending list.

For example, a user may directly check a list of events stored in the notification output list and the notification pending list displayed on the display 1210.

In operation S902 of FIG. 9, as the electronic apparatus 100 receives a user input of selecting an event from the displayed notification output list or the notification pending list and changing a list in which the selected event is to be stored, the electronic apparatus 100 may store the selected event in the changed list.

Referring to FIG. 10A, for example, a first event 1001 (for example, a received message 1) and a second event 1002 (for example, a received message 2) may be classified and stored in the notification output list 301. The electronic apparatus 100 may receive a user input of moving the first event 1001 stored in the notification output list 301 to the notification pending list 302. Accordingly, the electronic apparatus 100 may store the first event 1001 in the notification pending list 302.

In addition, for example, referring to FIG. 10B, the first event 1001 (for example, the received message 1) may be classified and stored in the notification output list 301, and the second event 1002 (for example, the received message 2) may be classified and stored in the notification pending list 302. At this time, the electronic apparatus 100 may receive a user input of moving the second event 1002 stored in the notification pending list 302 to the notification output list 301. Accordingly, the electronic apparatus 100 may store the second event 1002 in the notification output list 301. In operation S903 of FIG. 9, the electronic apparatus 100 may train the learning model 105 using, as training data, the selected event and a list in which the selected event is stored.

Referring to FIG. 10A, the learning model 105 may learn that the first event 1001 is classified in the notification pending list 302 based on the user input.

In addition, referring to FIG. 10B, the learning model 105 may learn that the second event 1002 is classified in the notification output list 301 based on the user input.

The electronic apparatus 100 according to an embodiment may train the learning model 105 by applying a higher priority to an event classified based on a classification input of the user.

For example, when notification information with respect to an event including a context corresponding to the event that has been classified in the notification output list by the classification input of the user is subsequently output, the user may respond with a different response pattern such as not checking. The learning model 105 may determine to classify, in the notification output list that has been directly classified by the user for a certain number of times or more, an event including a context to which a high priority is applied.

FIGS. 10A and 10B illustrate an example embodiment and the disclosure is not limited thereto.

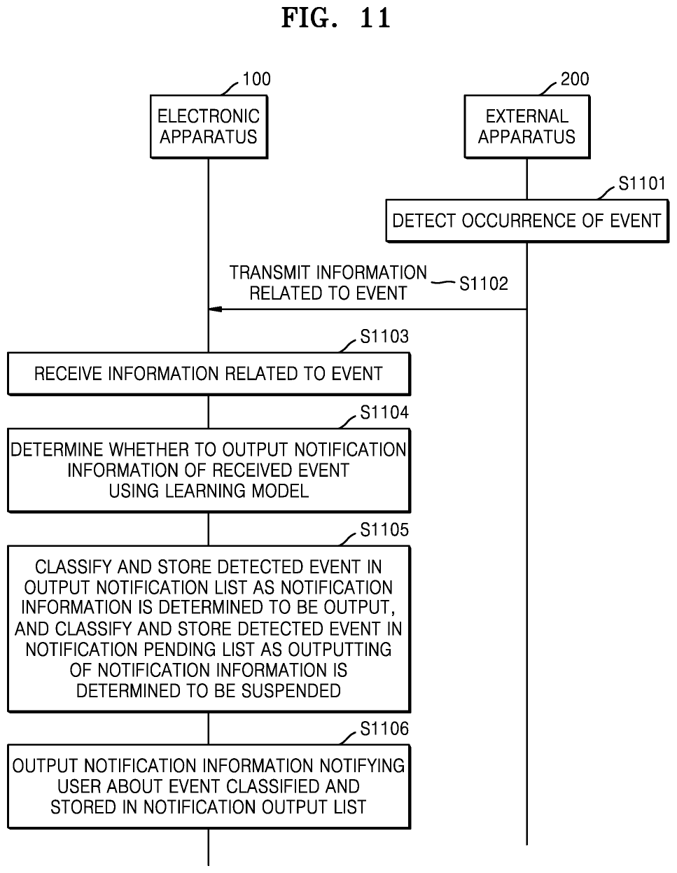

FIG. 11 is a signal flow diagram illustrating an example of receiving an event generated in an external apparatus 200, according to various embodiments.

According to an embodiment, the electronic apparatus 100 may determine, using the learning model 105, whether to output notification information of an event with respect to an event detected in the external apparatus 200 connectable via a communication network.

According to an embodiment, the electronic apparatus 100 may be an apparatus previously registered in the electronic apparatus 100. For example, the external apparatus 200 may be an apparatus registered through transmission and reception of identification information with the electronic apparatus 100.

The electronic apparatus 100 according to an embodiment and the external apparatus 200 may transmit and receive data to and from each other through a communication network. For example, the electronic apparatus 100 may be paired with the external apparatus 200 located within a short-range communication range.

According to an embodiment, the communication network may be formed by at least one of a wired communication network or a wireless communication network. For example, a communication network used to implement the Internet of Things may include mobile communication (for example, wireless broadband (WiBro), worldwide interoperability for, microwave access (WiMAX), code-division multiple access (CDMA), wideband CDMA (WCDMA), third generation (3G), fourth generation (4G), fifth generation (5G), or the like), short-range communication (for example, near field communication (NFC), Bluetooth, wireless LAN (WLAN) (Wi-Fi), or the like), and/or low-power long-range communication (for example, TV white space (TVWS), weightness, or the like), or the like.

In addition, the external apparatus 200 according to an embodiment may be implemented in various forms, such as, for example, and without limitation, a smart phone, a television (TV), a wearable device, a tablet personal computer (PC), a desktop, a laptop computer, a mobile phone, an e-book terminal, a digital broadcasting terminal, a personal digital assistant (PDA), a portable multimedia player (PMP), a digital camera, a camcorder, a navigation device, a MP3 player, a media player, a micro-server, a GPS device, or the like.

In operation S1101 of FIG. 11, the external apparatus 200 may detect occurrence of an event. In operation S1102, the external apparatus 200 may transmit information related to the event to the electronic apparatus 100.

The event generated in the external apparatus 200 according to an embodiment may refer, for example, to information or an action that occurs through an application installed in the external apparatus 200 or is received by the external apparatus 200 from the outside. For example, the event may include message reception, email reception, missed call notification reception, an advertisement occurred in the installed application, a notification, or the like, but is not limited thereto.

According to an embodiment, information related to an event may include the type and content of an event occurred in the external apparatus 200. For example, when a message reception event is detected in the external apparatus 200, information related to the event which includes the content of the received message and sender information of the message may be transmitted to the electronic apparatus 100.

In addition, according to an embodiment, the external apparatus 200 may transmit, to the electronic apparatus 100, a request signal requesting to output or hold off notification information related to an event. The external apparatus 200 may request the electronic apparatus 100 to determine whether outputs notification information related to an event and outputs or suspends the notification information related to the event on the electronic apparatus 100.

In operation S1103, the electronic apparatus 100 may receive the information related to the event from the external apparatus 200. In operation S1104, the electronic apparatus 100 may determine whether to output notification information of the received message using a learning model.

According to an embodiment, the electronic apparatus 100 may determine whether to output the notification information of the event in response to the request signal received from the external apparatus 200.

Operation S1104 may correspond to operation S202 of FIG. 2, therefore, detailed description thereof may not be repeated here.

In operation S1105, the electronic apparatus 100 may classify and store the detected event in a notification output list as the electronic apparatus 100 determines to output the notification information, and may classify and store the detected event in the notification pending list as the electronic apparatus 100 determines to suspend an output of the notification information. Operation S1105 of FIG. 11 may correspond to operation S301 of FIG. 3, therefore, detailed description thereof may not be repeated here.

In operation S1106, the electronic apparatus 100 may output the notification information notifying the user about the event classified and stored in the notification output list. Operation S1106 of FIG. 11 may correspond to operations S301 and S302 of FIG. 3, therefore, detailed description thereof may not be repeated here.

FIG. 12 is a block diagram illustrating an example of the electronic apparatus 100 according to various embodiments.

FIG. 13 is a block diagram illustrating the electronic apparatus 100 in greater detail, according to various embodiments.

As shown in FIG. 12, the electronic apparatus 100 according to various embodiments may include the memory 1700, the notification management module 1740 on the memory 1700, and the processor 1300. However, not all of the components shown in FIG. 12 are essential components of the electronic apparatus 100. The electronic apparatus 100 may be implemented by more components than the components shown in FIG. 12, or may be implemented by fewer components than the components illustrated in FIG. 12.

For example, as shown in FIG. 13, the electronic apparatus 100 according to various embodiments may further include a user input unit (e.g., including input circuitry) 1100, an output unit (e.g., including output circuitry) 1200, a sensing unit (e.g., including various sensors and/or sensing circuitry) 1400, a communication unit (e.g., including communication circuitry) 1500, an audio/video (A/V) input unit (e.g., including A/V input circuitry) 1600, in addition to the memory 1700 and the processor (e.g., including processing circuitry) 1300.

The user input unit 1100 may include various input circuitry and may refer, for example, to a unit through which a user inputs data for controlling the electronic apparatus 100. Examples of the user input unit 1100 may include, but are not limited to, a key pad, a dome switch, a touch pad (a contact capacitance method, a pressure resistive film method, an infrared detection method, a surface ultrasonic conduction method, an integral tension measurement method, a Piezo effect method, or the like), a jog wheel, a jog switch, or the like. Also, the electronic apparatus 100 may be connected to a microphone 1620 and receive an audio input for controlling the electronic apparatus 100.

The output unit 1200 may include various output circuitry and output an audio signal, a video signal, a vibration signal, or the like, and the output unit 1200 may include the display 1210, the sound output unit (e.g., including sound output circuitry) 1220, and the vibration motor 1230.

The display 1210 displays and outputs information processed by the electronic apparatus 100.

When the display 1210 and a touch pad are formed in a layered structure to form a touch screen, the display 1210 may also be used as an input apparatus in addition to an output apparatus. The display 1210 may include at least one of a liquid crystal display, a thin-film transistor-liquid crystal display, an organic light-emitting diode display, a flexible display, a three-dimensional (3D) display, or an electrophoretic display.

The display 1210 may include a light-emitting element (not shown). For example, the light-emitting element (not shown) may include, but is not limited to, a light-emitting diode and a display panel.

The sound output unit 1220 may include various sound output circuitry and output sound data which is received from the communication unit 1500 or stored in the memory 1700.

The processor 1300 may include various processing circuitry and generally controls an overall operation of the electronic apparatus 100. For example, the processor 1300 may generally control the user input unit 1100, the output unit 1200, the communication unit 1500, and the A/V input unit 1600 by executing a program stored in the memory 1700.

The processor 1300 controls a signal flow between internal components of the electronic apparatus 100 and performs a function of processing data. When a user's input occurs or a condition that is preset and stored is satisfied, the processor 1300 may execute an operation system (OS) and various applications that are stored in the memory 1700.

The processor 1300 may control an operation of the electronic apparatus 100 to perform functions of the electronic apparatus 100 described in FIGS. 1, 2, 3, 4, 5, 6, 7, 8, 9, 10A, 10B and 11.

The processor 1300 may include random access memory (RAM) that stores a signal or data input from the outside or is used as a storage area corresponding to various tasks performed by the electronic apparatus 100, and read only memory (ROM) and a processor in which a control program for controlling the electronic apparatus 100 is stored.

The processor 1300 may be implemented as a system-on-chip (SoC) in which a core (not shown) and a graphic processor (GPU) are integrated. The processor 1300 may include a single core, a dual core, a triple core, a quad core, and a multiple of cores.

In addition, the processor 1300 may be implemented as a main processor (not shown) and a sub processor (not shown) that operates in a sleep mode.

The processor 1300 may be include one or a plurality of processors. At this time, the one or the plurality of processors may include a general-purpose processor such as a central processing unit (CPU), a dedicated processor, an application processor (AP), a graphic processing unit (GPU), or the like, a graphic-only processor such as a vision processing unit (VPU), or an artificial intelligence-only processor such as a neural processing unit (NPU). The one or the plurality of processors control to process input data according to a predefined operation rule or an artificial intelligence model stored in a memory. When the one or the plurality of processors include an artificial intelligence-only processor, the artificial intelligence-only processor may be designed with a hardware structure specialized for processing a particular artificial intelligence model.

According to an embodiment, the processor 1300 may, by executing one or more instructions stored in the memory 1700, detect occurrence of an event in the electronic apparatus 100.

According to an embodiment, the processor 1300 may, by executing the one or more instructions stored in the memory 1700, determine whether to output notification information of the detected event using a learning model that has learned a user response pattern in response to a certain event including a certain text.

According to an embodiment, the processor 1300 may, by executing the one or more instructions stored in the memory 1700, classify and store a detected event in a notification output list as notification information is determined to be output and classify and store a detected event in a notification pending list as an output of notification information is determined to be hold off.

According to an embodiment, the processor 1300 may, by executing the one or more instructions stored in the memory 1700, output notification information notifying the user about an event classified and stored in the notification output list.

According to an embodiment, the processor 1300 may, by executing the one or more instructions stored in the memory 1700, receive a user input in response to the notification information and train a learning model using, as training data, the detected event and a user input pattern in response to the notification information. The user response pattern may include at least one of an input of checking notification information or an input of deleting notification information.

According to an embodiment, the processor 1300 may, by executing the one or more instructions stored in the memory 1700, display the notification pending list. The processor 1300 may, by executing the one or more instructions stored in the memory 1700, receive a user input of checking an event included in the notification pending list. The processor 1300 may, by executing the one or more instructions stored in the memory 1700, train the learning model using, as training data, a checked event and a user response pattern of checking an event included in the notification pending list.

According to an embodiment, the processor 1300 may, by executing the one or more instructions stored in the memory 1700, display the notification output list. The processor 1300 may, by executing the one or more instructions stored in the memory 1700, receive a user input of deleting an event included in the notification output list. The processor 1300 may, by executing the one or more instructions stored in the memory 1700, train the learning model using, as training data, a deleted event and a user response pattern of deleting an event included in the notification output list.

According to an embodiment, the processor 1300 may, by executing the one or more instructions stored in the memory 1700, display the notification output list and the notification pending list. The processor 1300 may, by executing the one or more instructions stored in the memory 1700, store a selected event in a changed list upon reception of a user input of selecting an event from the displayed notification output list or notification pending list and changing a list in which the selected event is to be stored. The processor 1300 may, by executing the one or more instructions stored in the memory 1700, train the learning model using, as training data, the selected event and the list in which the selected event is stored.

The processor 1300 may, by executing the one or more instructions stored in the memory 1700, receive an event occurred in the external apparatus 200 connected to the electronic apparatus 100 through the communication unit 1500. The processor 1300 may, by executing the one or more instructions stored in the memory 1700, determine whether to output notification information of a received event using the learning model that has learned a user response pattern in response to a certain event including a certain text.

The sensing unit 1400 may include various sensors and/or sensing circuitry and may detect a state of the electronic apparatus 100 or a state around the electronic apparatus 100 and transmit the detected information to the processor 1300.

The sensing unit 1400 may include, but is not limited to, at least one of a magnetic sensor 1410, an acceleration sensor 1420, a temperature/humidity sensor 1430, an infrared sensor 1440, a gyroscope sensor 1450, a position sensor (for example, GPS) 1460, an atmospheric pressure sensor 1470, a proximity sensor 1480, or an RGB sensor (illuminance sensor) 1490. Because a function of each sensor may be intuitively inferred by one of ordinary skill in the art, a detailed description thereof may not be provided here.

The communication unit 1500 may include various communication circuitry included in at least one component that allows the electronic apparatus 100 to communicate with the outside. For example, the communication unit 1500 may include a short-range wireless communication unit 1510, a mobile communication unit 1520, and a broadcast reception unit 1530.

The short-range wireless communication unit 1510 may include, but is not limited to, a Bluetooth communication unit, a Bluetooth low energy (BLE) communication unit, a near-field communication unit, a WLAN (Wi-Fi) communication unit, a Zigbee communication unit, an infrared data association (IrDA) communication unit, a Wi-Fi direct (WFD) communication unit, an Ant+ communication unit, or the like.

The mobile communication unit 1520 transmits or receives a wireless signal to or from at least one of a base station, an external terminal, or a server on a mobile communication network. Herein, the wireless signal may include a voice call signal, a video call signal, or data in various forms according to message/multimedia message transmission and reception.

The broadcast reception unit 1530 receives a broadcast signal and/or broadcast-related information from the outside through a broadcast channel. The broadcast channel may include a satellite channel and a terrestrial channel. According to an embodiment, the electronic apparatus 100 may not include the broadcast reception unit 1530.

The A/V input unit 1600 may include various A/V input circuitry and is configured to input an audio signal or a video signal, and may include a camera 1610 and the microphone 1620.

The camera 1610 may obtain an image frame such as a still image or a video through an image sensor in a video call mode or a photographing mode. An image captured through the image sensor may be processed through the processor 1300 or a separate image processing unit (not shown).

An image frame processed by the camera 1610 may be stored in the memory 1700 or transmitted to the outside through the communication unit 1500. Two or more cameras 1610 may be provided according to the configuration of a terminal.

The microphone 1620 receives an external sound signal and processes the received external sound signal as electrical voice data. For example, the microphone 1620 may receive a sound signal from an external device or a speaker. The microphone 1620 may use various noise removal algorithms removing noise generated in an operation of receiving the external sound signal.

The memory 1700 may store a program processing and controlling the processor 1300 and may store data input to the electronic apparatus 100 or output from the electronic apparatus 100.

The memory 1700 may include at least one type of a storage medium from among a flash memory type, a hard disk type memory, a multimedia card micro type memory, a card-type memory (e.g., a secure digital (SD) memory, an extreme digital (XD) memory, or the like), random-access memory (RAM), static random-access memory (SRAM), read-only memory (ROM), electrically erasable programmable read-only memory (EEPROM), programmable read-only memory (PROM), a magnetic memory, a magnetic disk, and an optical disk.

Programs stored in the memory 1700 may be classified into a plurality of modules according to functions thereof, and may be classified into, for example, a user interface (UI) module 1710, a touch screen module 1720, a notification module 1730, the notification management module 1740, or the like.

The UI module 1710 may provide a specialized UI, a graphic user interface (GUI), or the like that are interlocked with the electronic apparatus 100 for each application.

The touch screen module 1720 may detect a touch gesture of a user on a touch screen and transmit information related to the touch gesture to the processor 1300. The touch screen module 1720 according to some embodiments of the disclosure may recognize and analyze a touch code. The touch screen module 1720 may be configured as separate hardware including a controller.

The notification module 1730 may provide an output signal notifying the occurrence of an event of the electronic apparatus 100. The notification module 1730 may control to output the output signal as a video signal or an audio signal.

The notification module 1730 may output a notification signal in a form of the video signal through the display 1210, or may output a notification in a form of the audio signal through the sound output unit 1220. Also, the notification module 1730 may output a notification signal through vibration through the vibration motor 1230.

When an event occurs, the notification management module 1740 may train the learning model 105 using, as training data, a user response pattern in response to notification information of the event.

In addition, when an event occurs, the notification management module 1740 may, using the trained learning model 105, classify the event into the notification output list or the notification pending list.

The above-described embodiments of the disclosure may be written as a program executable in a computer, and may be implemented in a general-purpose digital computer that operates the program using a medium readable by a computer. A structure of data used in the above-described embodiments of the disclosure may be recorded on a computer-readable medium through various units. In addition, the above-described embodiments of the disclosure may be implemented in a form of a recording medium including instructions executable by a computer, such as a program module executed by a computer. For example, methods implemented as a software module or an algorithm may be stored in a computer-readable recording medium as codes or program instructions that a computer may read and execute.

The computer-readable medium may be an arbitrary recording medium accessible by a computer, and examples thereof include volatile and non-volatile media and separable and non-separable media. The computer-readable medium may include a storage medium such as a magnetic storage medium including ROM, a floppy disk, a hardware disk, or the like and an optically readable medium, for example, CD-ROM, DVD, or the like, but is not limited thereto. The computer-readable medium may include a computer storage medium and a communication medium.

In addition, a plurality of computer-readable recording media may be distributed over network-connected computer systems, and data stored in the distributed recording media, for example, at least one of a program instruction or a code may be executed by a computer.

Particular implementations described in the disclosure merely examples, and do not limit the scope of the disclosure in any way. For brevity of the disclosure, descriptions of electronic configurations in the related art, control systems, software, and other functional aspects of the systems may be omitted.

The above description of the disclosure is provided for the purpose of illustration, and it would be understood by those of skill in the art that various changes and modifications may be made without changing technical conception and essential features of the disclosure. Thus, it is clear that the above-described example embodiments of the disclosure are illustrative in all aspects and do not limit the disclosure. For example, each component described in a single type may be executed in a distributed manner, and components described distributed may also be executed in an integrated form.

In the disclosure, the use of any and all examples, or exemplary language (e.g., “such as”) provided herein, is intended merely to better illuminate the disclosure and does not pose a limitation on the scope of the disclosure unless otherwise claimed.

Moreover, no item or component is essential to the practice of the disclosure unless the element is specifically described as “essential” or “critical”.

While this disclosure has been illustrated and described with reference to various example embodiments thereof, it will be understood by those skilled in the art that various changes in form and details may be made therein without departing from the spirit and scope of the disclosure, including the appended claims.

Terms described in the disclosure, such as “ . . . unit”, “module”, or the like refer to a unit processing at least one function or operation, which may be implemented as hardware, software, or a combination of hardware or software.

The “ . . . unit” and “module” may be stored in an addressable storage medium and may be implemented by a program executable by a processor.

For example, the “unit” and “module” may be implemented by components such as software components, object-oriented software components, class components, and task components, processes, functions, properties, procedures, subroutines, segments of program code, drivers, firmware, microcode, circuits, data, databases, data structures, tables, arrays, and variables.

In the disclosure, the description “A may include one of a1, a2, and a3” broadly refers to an example element that may be included in the element A is a1, a2, or a3.

The elements that may configure the element A are not limited to a1, a2, or a3 due to the above description. Therefore, it should be noted that elements that may configure A are not interpreted exclusively, and that other elements not illustrated other than a1, a2, and a3 are not excluded.

In addition, in the disclosure A may include a1, a2, or a3. The above disclosure does not mean that the elements configuring A are necessarily selectively determined within a predetermined set. It should be noted that, for example, the description above is not necessarily interpreted as limiting, as that a1, a2, or a3 selected from a set including a1, a2, and a3 configures component A.

What is claimed is:

1. An operating method of an electronic apparatus, the method comprising:
detecting occurrence of an event in the electronic apparatus; and
determining whether to output notification information about the detected event using a learning model trained based on a user response pattern in response to a certain event including a certain context.

2. The method of claim 1, further comprising:
classifying and storing the detected event in a notification output list as the notification information is determined to be output and classifying and storing the detected event in a notification pending list as outputting of the notification information is determined to be suspended; and
outputting notification information notifying a user about the event classified and stored in the notification output list.

3. The method of claim 2, further comprising:
receiving a user input in response to the notification information; and
training the learning model using, as training data, the detected event and a user response pattern in response to the notification information,
wherein the user response pattern includes at least one of an input of checking the notification information or an input of deleting the notification information.

4. The method of claim 2, further comprising:
displaying the notification pending list;
receiving a user input of checking an event included in the notification pending list; and
training the learning model using, as training data, the checked event and a user response pattern of checking an event included in the notification pending list.

5. The method of claim 2, further comprising:
displaying the notification output list;
receiving a user input of deleting the event included in the notification output list; and
training the learning model using, as training data, the deleted event and a user response pattern of deleting the event comprised in the notification output list.

6. The method of claim 2, further comprising:
displaying the notification output list and the notification pending list;
receiving a user input of selecting an event from the displayed notification output list or the notification pending list and changing a list in which the selected event is to be stored, and storing the selected event in the changed list; and
training the learning model using, as training data, the selected event and the list in which the selected event is stored.

7. The method of claim 1, wherein the detecting of the occurrence of the event comprises receiving an event occurring in an external apparatus connected to the electronic apparatus.

8. The method of claim 1, wherein the event comprises at least one of message reception, email reception, a notification generated from an application, or missed call notification reception.

9. An electronic apparatus comprising:
a memory storing one or more instructions; and
a processor configured to execute the one or more instructions stored in the memory to:
detect occurrence of an event in the electronic apparatus, and
determine whether to output notification information about the detected event using a learning model trained based on a response pattern in response to a certain event including a certain context.

10. The electronic apparatus of claim 9, wherein the processor is further configured to execute the one or more instructions to:
classify and store the detected event in a notification output list as the notification information is determined to be output and classify and store the detected event in a notification pending list as outputting of the notification information is determined to be suspended, and
output notification information about the event classified and stored in the notification output list.

11. The electronic apparatus of claim 10, wherein the processor is further configured to execute the one or more instructions to:
receive an input in response to the notification information, and
train the learning model using, as training data, the detected event and a response pattern in response to the notification information,
wherein the response pattern includes at least one of an input of checking the notification information or an input of deleting the notification information.

12. The electronic apparatus of claim 10, wherein the processor is further configured to execute the one or more instructions to:
display the notification pending list,
receive an input of checking an event included in the notification pending list, and
train the learning model using, as training data, the checked event and a response pattern of checking an event included in the notification pending list.

13. The electronic apparatus of claim 10, wherein the processor is further configured to execute the one or more instructions to:
display the notification output list,
receive an input of deleting the event included in the notification output list, and
train the learning model using, as training data, the deleted event and a response pattern of deleting the event included in the notification output list.

14. The electronic apparatus of claim 10, wherein the processor is further configured to execute the one or more instructions to:
display the notification output list and the notification pending list,
receive an input of selecting an event from the displayed notification output list or the notification pending list and changing a list in which the selected event is to be stored and store the selected event in the changed list; and
train the learning model using, as training data, the selected event and the list in which the selected event is stored.

15. The electronic apparatus of claim 9, wherein the processor is further configured to execute the one or more instructions to receive an event occurring in an external apparatus connected to the electronic apparatus.

16. The electronic apparatus of claim 9, wherein the event comprises at least one of message reception, email reception, a notification generated from an application, or missed call notification reception.

17. A non-transitory computer-readable recording medium having recorded thereon a program for executing the operating method of claim 1 on a computer.
